(19) United States
(12) Patent Application Publication
(10) Pub. No.: US 2009/0006938 A1
(43) Pub. Date: Jan. 1, 2009

(54) Method and apparatus for searching web browser using zoom

(75) Inventors: Byung-In Yoo, Seoul (KR); Jong-Ho Lea, Seongnam-si (KR); Yeun-Bae Kim, Seongnam-si (KR); Hye-Jeong Lee, Seoul (KR); Ji-Hye Chung, Seoul (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD., Suwon-si (KR)

(21) Appl. No.: 12/149,523

(22) Filed: May 2, 2008

(30) Foreign Application Priority Data
Jun. 27, 2007 (KR) 10-2007-0063851

(51) Int. Cl. G06F 17/00

(52) U.S. Cl. 715/205

(57) ABSTRACT

Disclosed is a method and apparatus for searching a web browser using a zoom operation. A method of searching a web browser according to an aspect of the invention includes locating a pointer on a web browser using an input device, selecting one or more hyperlinks on the basis of the distance between the pointer and hyperlinks and displaying the hyperlinks, and outputting, when a screen of the web browser is enlarged and the size of the screen is out of a predetermined enlargement range, a page, which is linked to one of the selected and displayed hyperlinks, to an entire screen of the web browser.

### CROSS REFERENCE TO RELATED APPLICATION

This application claims priority from Korean Patent Application No. 10-2007-0063851 filed on Jun. 27, 2007, in the Korean Intellectual Property Office, the disclosure of which is incorporated herein by reference in its entirety.

### BACKGROUND OF THE INVENTION

1. Field of the Invention

The present invention relates to a method and apparatus for searching a web browser using a zoom. More particularly, the present invention relates to a method and apparatus for searching a web browser that is capable of allowing a screen of a web browser including hyperlinks to be converted by enlarging and reducing the screen using the zoom function, and that allows a user to easily search the web browser.

2. Description of the Related Art

An Internet protocol television (hereinafter, simply referred to as IPTV) provides various multimedia content, such as real-time broadcasting content, video on demand (VOD, the Internet, and Television commerce (T-commerce, in two ways, according to a user's request, while using an Internet protocol scheme through a high-speed Internet network. In recent years, as the market has increasingly expanded, IPTV has been rapidly developed.

IPTV searches web content using an input device, such as a mouse or a remote controller, and uses the web content. The invention provides a method of easily using and searching web content.

When a user searches a web browser at a location that is a predetermined distance distant from the IPTV (that is, location where the user watches the IPTV, a large amount of texts and hyperlinks exist on a web page. Therefore, a function of enlarging and reducing a web page is often used. At this time, since it is difficult for the user to click a specific hyperlink using the remote controller, it is required that after a pointer is located on the web page, a screen of the web page is freely converted using a screen enlarging and reducing function, and the web page is searched.

In addition, among methods of searching a web browser according to the related art, there is a method in which a new screen, which is connected to a hyperlink, is displayed by clicking the hyperlink. However, according to this method, since the screen is disconnected at the time of converting the screen, it is not possible to smoothly convert the screen.

The application field of the invention is not limited to IPTVs, and the invention may also be applied to various environments, such as a PC and a mobile terminal searching a web browser. Further, the invention is not limited to the web, and may be a document viewer having hyperlinks or a document creator.

### SUMMARY OF THE INVENTION

An object of the present invention is to provide a method and apparatus for searching a web browser that allows a screen of the web browser to be easily and smoothly converted by enlarging and reducing the screen using zoom, that improves search environments of the web browser for a user.

Objects of the present invention are not limited to those mentioned above, and other objects of the present invention will be apparent to those skilled in the art through the following description.

According to an aspect of the present invention, there is provided a method of searching a web browser, the method including locating a pointer on a web browser using an input device, selecting one or more hyperlinks on the basis of the distance between the pointer and hyperlinks and displaying the hyperlinks, and outputting, when a screen of the web browser is enlarged and the size of the screen is out of a predetermined enlargement range, a page, which is linked to one of the selected and displayed hyperlinks, to an entire screen of the web browser.

According to another aspect of the present invention, there is provided an apparatus for searching a web browser using zoom, the apparatus including an input device locating a pointer on a web browser and enlarging and reducing a screen of the web browser, a distance-calculating unit calculating the distance between the pointer and hyperlinks, a hyperlink-selection/display unit selecting one or more hyperlinks on the basis of the distance and displaying the selected hyperlinks, and a screen-converting unit outputting, when the screen of the web browser is enlarged and a size of the screen is out of a predetermined enlargement range, a page, which is linked to one of the selected and displayed hyperlinks, to an entire screen of the web browser.

### BRIEF DESCRIPTION OF THE DRAWINGS

The patent or application file contains at least one drawing executed in color. Copies of this patent or patent application publication with color drawing(s) will be provided by the Office upon request and payment of the necessary fee. The above and other features and advantages of the present invention will become apparent by describing in detail preferred embodiments thereof with reference to the attached drawings in which:

FIG. 1 is a flowchart illustrating a screen-converting process when enlarging a screen of a web browser in a method of searching a web browser using zoom according to an embodiment of the invention;

FIG. 2 is a flowchart illustrating a screen-converting process when reducing a screen of a web browser in a method of searching a web browser using zoom according to an embodiment of the invention;

FIG. 3 is a diagram illustrating a state where hyperlinks around a pointer are selected and highlighted;

FIG. 4 is a diagram illustrating preview thumbnails that show content of pages connected to hyperlinks around a pointer as a screen is enlarged by zoom-in;

FIG. 5 is a diagram illustrating a state where a page, which is linked to a hyperlink closest to a pointer, is converted as a new current screen as the screen shown in FIG. 4 is further enlarged;

FIG. 6 is a diagram illustrating a state where a screen is converted into a screen right before being converted in FIG. 5 as a screen shown in FIG. 5 is reduced by zoom-out;

FIG. 7 is a diagram illustrating the distance between a pointer and hyperlinks around the pointer and the transparency and sizes of preview thumbnails according to the distance;

FIGS. 8 and 9 are diagrams illustrating locations of preview thumbnails at hyperlinks according to an embodiment of the invention; and

FIG. 10 is a diagram illustrating an apparatus for searching a web browser using zoom according to an embodiment of the invention.

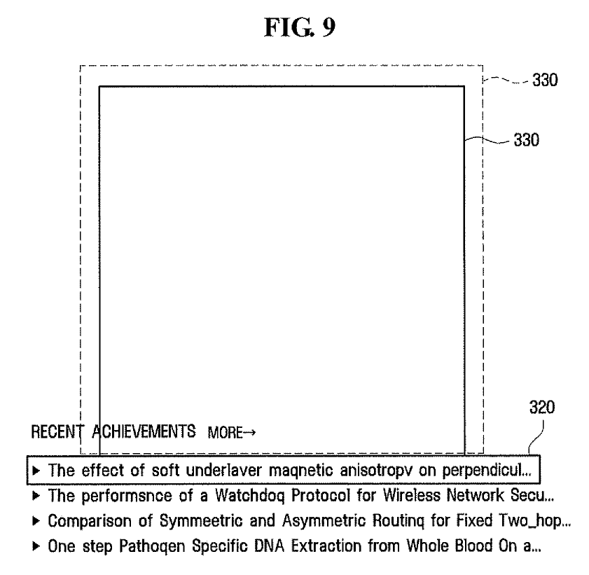

### DESCRIPTION OF THE PREFERRED EMBODIMENTS

Advantages and features of the present invention and methods of accomplishing the same may be understood more readily by reference to the following detailed description of preferred embodiments and the accompanying drawings. The present invention may, however, be embodied in many different forms and should not be construed as being limited to the embodiments set forth herein. Rather, these embodiments are provided so that this disclosure will be thorough and complete and will fully convey the concept of the present invention to those skilled in the art, and the present invention will only be defined by the appended claims. Like identification codes refer to like elements throughout the specification.

The present invention will be described hereinafter with reference to block diagrams or flowchart illustrations of a method and apparatus for searching a web browser using a zoom function. It should be understood that blocks in the accompanying block diagrams and compositions of steps in flow charts can be performed by computer program instructions. These computer program instructions can be loaded onto processors of, for example, general-purpose computers, special-purpose computers, and programmable data processing apparatuses. Therefore, the instructions performed by the computer or the processors of the programmable data processing apparatus generate means for executing functions described in the blocks in block diagrams or the steps in the flow charts. The computer program instructions can be stored in a computer available memory or a computer readable memory of the computer or the programmable data processing apparatus in order to realize the functions in a specific manner. Therefore, the instructions stored in the computer available memory or the computer readable memory can manufacture products including the instruction means for performing the functions described in the blocks in the block diagrams or the steps in the flow charts. Further, the computer program instructions can be loaded into the computer or the computer programmable data-processing apparatus. A series of operational steps is performed in the computer or the programmable data processing apparatus to generate a process executed by the computer, which makes it possible for the instructions driving the computer or the programmable data processing apparatus to provide steps of executing the functions described in the blocks of the block diagrams or the steps of the flow charts.

Each block or each step may indicate a portion of a module, a segment or a code including one or more executable instructions for performing a specific logical function (or functions). It should be noted that in some modifications of the present invention, the functions described in the blocks or the steps may be generated out of order. For example, two blocks or steps shown in series can be performed at the same time, or they can sometimes be performed in reverse order according to the corresponding functions.

In general, a web document has a document structure including hyperlinks, and content of the document has a two-dimensional structure which has rows and columns in a web browser. However, if considering the hyperlink, which moves a current page to another page at the time of selection, as one dimension, the web browser can be defined as a document having a three-dimensional structure. A user understands content on one page while viewing a matrix through the web browser at different viewing angles, and selects a hyperlink related to desired content among the content and reads another web document that is linked to the corresponding hyperlink. Further, the web document moves between the current page and the past pages by an anterior and posterior searching function of the web browser. Therefore, the web document that has the hyperlink may be defined as a three-dimensional web document.

The invention relates to a method of searching a three-dimensional web browser by using a function for enlarging and reducing a screen and a location of a pointer.

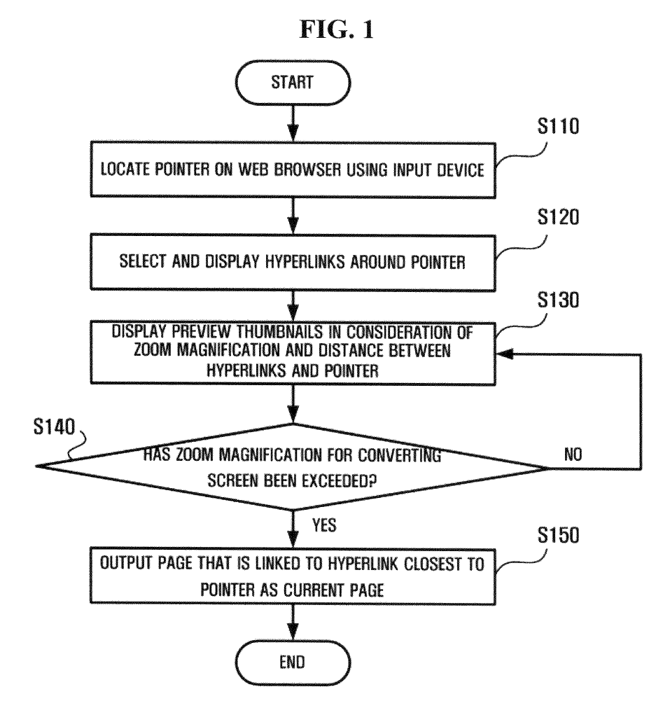

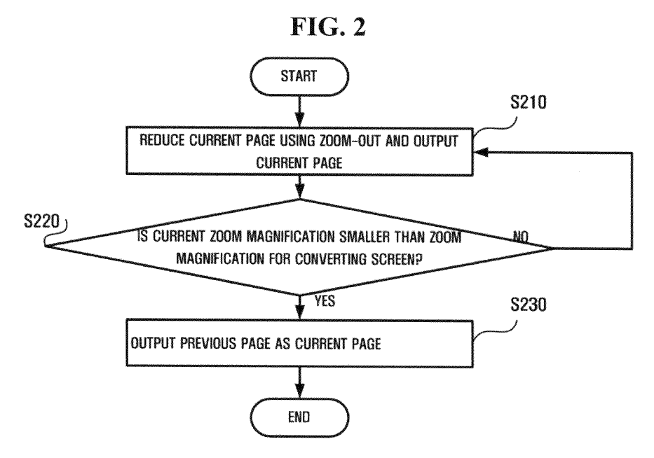

FIG. 1 is a flowchart illustrating a screen-converting process when enlarging a screen of a web browser in a method of searching a web browser using a zoom function, according to an embodiment of the invention, and FIG. 2 is a flowchart illustrating a screen-converting process when reducing a screen of a web browser in a method of searching a web browser using a zoom function, according to an embodiment of the invention.

First, the description is given to a screen-converting process when enlarging a screen using zoom-in.

A method of searching a web browser using zoom according to an embodiment of the invention includes locating a pointer 310 on a web browser 300 by using an input device 510 S110, selecting one ore more hyperlinks 320 on the basis of the distance between the pointer 310 and the hyperlinks on a screen of the web browser 300 and displaying the selected hyperlinks S120, displaying preview thumbnails 330 of the selected hyperlinks 320 as the screen is enlarged S130, determining whether a size of the screen exceeds the predetermined zoom magnification as the screen is enlarged S140, and outputting, when it is determined that the size of the screen has exceeded the predetermined zoom magnification, a page, which is linked to one of the selected and displayed hyperlinks 320, to the entire screen of the web browser 300 S150.

First, the pointer 310 is located on the web browser 300 by using the input device 510 S110. At this time, the input device 510 may be a mouse, a remote controller or the like. The pointer 310 can be moved on the web browser by moving the mouse in the case of the mouse, and by clicking a button on a remote controller in the case of the remote controller. If the pointer 310 can be located on the web browser 300 while moving, the input device 510 is not limited to the above-described examples, and any other devices may be used. Further, the embodiment of the invention can be applied not only to the web browser but also to a document viewer having hyperlinks, a document creator, and the like.

At this time, using the input device 510, one or more hyperlinks 320 are selected on the basis of the distance between the pointer 310 and the hyperlinks around the pointer 310 and displayed S120. If the hyperlinks do not exist around the pointer 310, no hyperlink 320 may be selected. At this time, the predetermined number of hyperlinks 320, which are selected from among the plurality of hyperlinks on the web browser and displayed, may be selected by the following method.

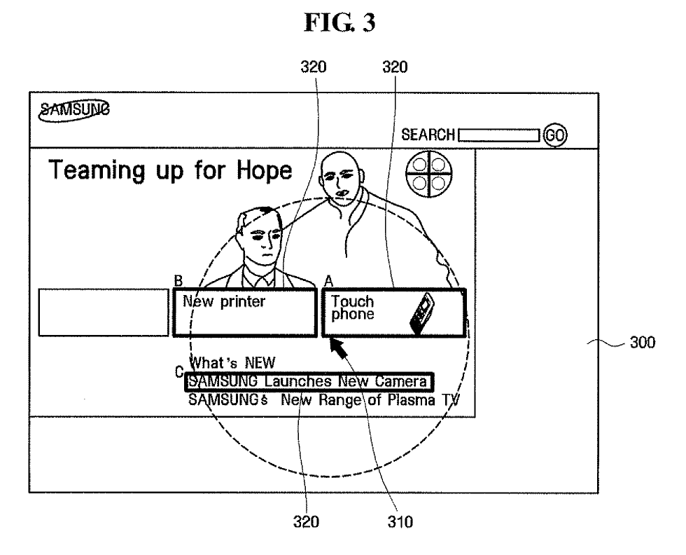

The predetermined number of hyperlinks 320, which are closest to the pointer 310 when comparing the distance between the pointer 310 and the hyperlinks on the web browser 300, may be selected and displayed. FIG. 3 shows a state where hyperlinks A, B, and C around a pointer 310 are selected and highlighted. From FIG. 3, it can be understood that the three hyperlinks 320, which are close to the center of the pointer 310, are selected and displayed.

Alternatively, the hyperlinks 320, which exist in a region with a predetermined shape, such as a rectangle or circle, around the pointer, may be selected and displayed. That is, the hyperlinks 320, which are within a range of the predetermined distance from the pointer 310, may be selected.

The hyperlinks 320 around the pointer 310, which are selected and displayed, may be selected according to various reference conditions as well as the above-described two methods.

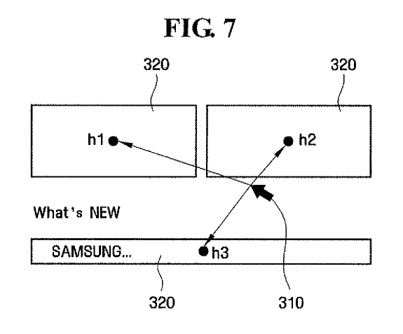

At this time, as the pointer 310 moves by the input device 510, the physical distance between the pointer 310 and the hyperlinks 320 around the pointer 310 may be calculated and updated in real time and stored in a separate material structure storage unit (not shown). The method of calculating the distance between the pointer 310 and the hyperlinks will be described below with reference to FIG. 7.

The selected hyperlinks 320 may be displayed by highlighting the boundaries between the hyperlinks 320, as shown in FIG. 3.

The screen of the web browser may be enlarged and reduced by using the above-described input device 510. The enlargement of the screen means that a size of a screen on a web browser 300 is increased as if the shape of the screen it is enlarged by a magnifying glass, without changing a structure or content of the web document. Further, the reduction of the screen means that the size of the screen on the web browser is decreased.

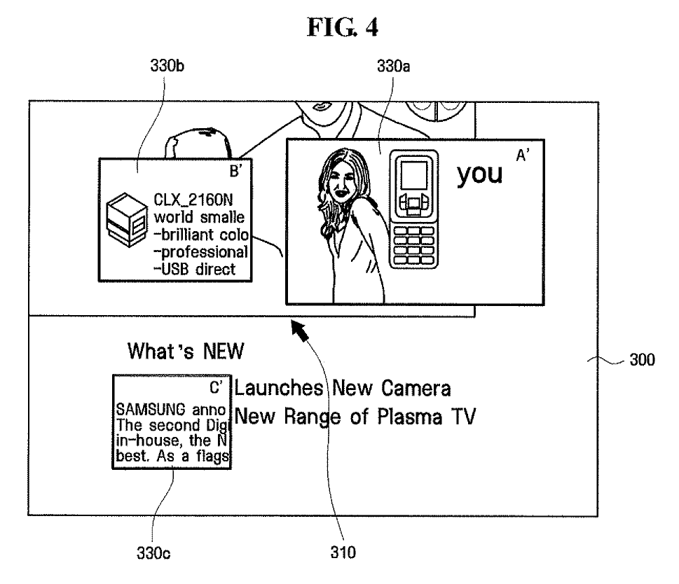

While the screen is enlarged by using the input device 510, the preview thumbnails 330, which show content of the pages linked to the selected and displayed hyperlinks 320, may be displayed S130. FIG. 4 shows preview thumbnails A′, B′, and C′ (that is, refer to reference numerals 330a, 330b, and 330c) that show actual content of pages linked to hyperlinks 320 around a pointer 310 as a screen is enlarged by zoom-in. Specifically, FIG. 4 shows a state where the preview thumbnails 330a, 330b, and 330c of the three hyperlinks 320 selected and displayed in FIG. 3 are displayed.

At this time, as the zoom-in is performed using the input device 510, the size of the preview thumbnail 330 gradually increases. When performing the zoom-out, the size of the preview thumbnail 330 may be decreased. That is, as the magnification of the screen increases, the size of the preview thumbnail 330 can increase.

Further, as the zoom-in is performed, the transparency of the preview thumbnail 330 can be changed. That is, as the magnification of the screen increases, the preview thumbnail 330 can be changed from the transparent state to the opaque state. Further, as the magnification of the screen is decreased by the zoom-out, the preview thumbnail 330 can be changed from the opaque state to the transparent state.

When the distance between the pointer 310 and the hyperlink is short, the preview thumbnail 330 of the corresponding hyperlink can be displayed to have a large size. Further, when the distance between the pointer 310 and the hyperlink is short, the preview thumbnail 330 of the corresponding hyperlink can be displayed to have small transparency. From FIG. 4, it can be understood that the preview thumbnail 330a of the hyperlink, which is closest to the pointer 310, is displayed to have the largest size.

Accordingly, in accordance with the magnification of the screen controlled by the user and the distance between the pointer 310 and the hyperlink 320, the size and transparency of the preview thumbnail 330 may be individually or simultaneously changed.

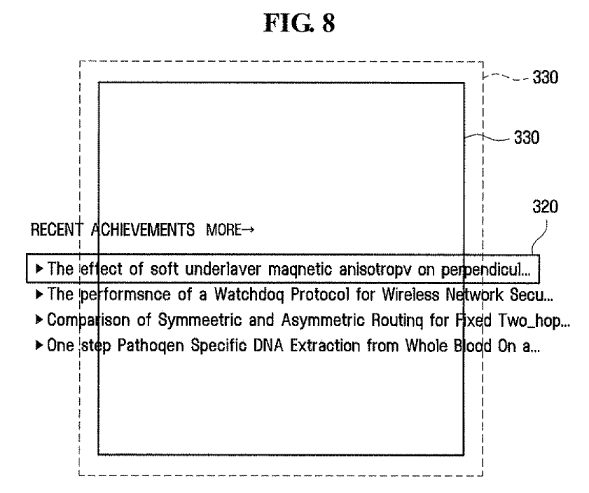

At this time, while the screen is enlarged by the input device 510, content of the web browser 300 can be enlarged up to the predetermined magnification, and then the preview thumbnail 330 can be displayed after the predetermined magnification is exceeded. For example, in a range of the screen enlarging magnification 2×, the preview thumbnails 220 of the hyperlinks 320 around the pointer 310 are not displayed, but the screen of the web browser 330 is enlarged. If the screen enlarging magnification 2× is exceeded, the preview thumbnails 330 of the selected hyperlinks 320 around the pointer 310 are displayed and the zoom magnification is increased. Accordingly, the sizes of the preview thumbnails 330 can be increased. Alternatively, instead of performing the process in which the screen of the web browser 300 is only enlarged up to the predetermined magnification (for example, 2×), the screen may be enlarged by the zoom-in and the preview thumbnails 330 may be displayed, such that the sizes of the preview thumbnails 330 are increased at the same time when the screen of the web browser 300 is enlarged. The locations of the preview thumbnails 330, which are relevant to the hyperlinks 320, is described below with reference to FIGS. 8 and 9.

Then, if the screen of the web browser 300 is continuously enlarged and the predetermined magnification range is exceeded S140, a page, which is linked to one of the selected and displayed hyperlinks 320, is output to the entire screen of the web browser 300, and the screen is converted S150. At this time, the screen is converted into a page which is linked to the hyperlink 330a closest to the pointer 310, among the selected and displayed hyperlinks 320 around the pointer 310.

As described above, while the preview thumbnails 330 of the hyperlinks 320 around the pointer 310 are displayed as the screen is enlarged, the sizes of the preview thumbnails 330 are increased, but the transparency of the preview thumbnails 330 is decreased. At the same time, the preview thumbnail 330 of the hyperlink 320, which is closest to the pointer 310, can be displayed in a larger size. Accordingly, as the screen is enlarged, the preview thumbnail 330a, which is closest to the pointer 310, is displayed in the largest size, among the plurality of preview thumbnails 330a, 330b, and 330c. If the screen is continuously enlarged and the predetermined magnification is exceeded, the current screen is converted into a screen that contains content of the preview thumbnail 330a that is closest to the pointer 310. Accordingly, the screen conversion can be smoothly performed.

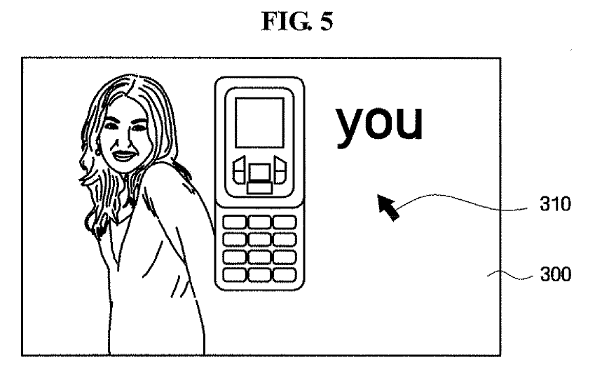

FIG. 5 shows a state where a page, which is linked to a hyperlink 320 closest to a pointer 310, is converted as a new current screen as the screen is further enlarged. While the preview thumbnail 330a of the hyperlink 320, which is closest to the pointer 310, is converted into a next screen, a page, which is linked to the hyperlink 320, is displayed as an entire screen on the web browser 300, as shown in FIG. 5. The previous page of the page, which is linked to the hyperlink 320 closest to the pointer 310, is displayed on an entire screen, may be stored in a separate material structure storage unit (not shown). The stored page may be used when the current screen is converted into the previous screen while the screen is reduced by zoom-out. The detailed description thereof is provided below. When the screen is converted by the hyperlink 320 closest to the pointer 310, magnification of the new screen is set to 1× in a state where zoom is not performed, and the screen may be displayed. At this time, if the user enlarges the screen by using the input device 510, the above-described processes are repeated.

A screen-converting process when reducing a screen using zoom-out is described in the following.

If the zoom-out is performed by the input device, the screen, which is currently displayed on the web browser, is reduced S210.

At this time, if the screen of the web browser 300 is reduced and the reduction of the screen is out of the predetermined reduction range, that is, the magnification of the screen is smaller than the zoom magnification for performing the screen conversion S220, the current screen is converted into the screen right before being converted in step S150 (S230).

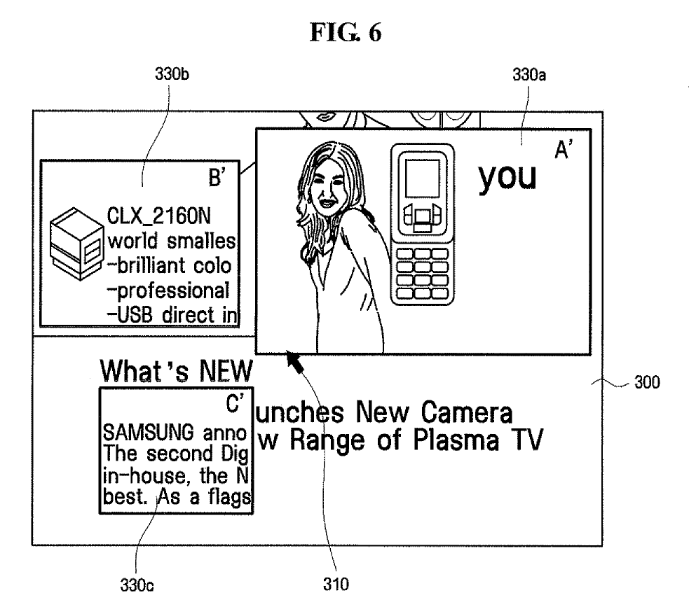

FIG. 6 is a diagram illustrating a state where a screen is converted into a screen right before being converted in FIG. 5 as a screen shown in FIG. 5 is reduced by zoom-out. While the zoom is executed, the screens of FIGS. 5 and 6 become anterior and posterior screens, respectively, and the screens can be changed. As described above, as the screen shown in FIG. 6, it is possible to display the screen that is stored in the material structure storage module (not shown) when the screen is converted in Step S150. At this time, as shown in FIG. 6, the preview thumbnails 330 around the pointer 310 are displayed. If the zoom-out is continuously performed, the sizes of the preview thumbnails 330 are reduced, and the transparency of the preview thumbnails 330 is increased.

FIG. 7 shows the distance between a pointer 310 and hyperlinks 320 around the pointer 310, and the transparency and sizes of preview thumbnails 330 according to the distance.

When it is assumed that coordinates of the pointer 310 are p (px, py) and coordinates of the hyperlinks 320 around the pointer 310 (central coordinates of the hyperlinks 320) are h1 (hx1, hy1, h2 (hx2, hy2, and h3 (hx3, hy3, the distance dn between the pointer P (refer to reference numeral 310) and the hyperlink hn (refer to reference numeral 320) can be calculated as represented by Equation 1.

dₙ=\sqrt{(px−hxₙ)²+(py−hyₙ)²} (1)

When it is assumed that the longest distance among the calculated distances is d1, the transparency of the preview thumbnail can be calculated by Equation 2.

$${Op}_{n} = ( \frac{{d}_{n}}{{d}_{1}} + Z ( \frac{{S}_{max}}{{S}_{c}} ) ) \times 50 \leq 100 \qquad ( 2 )$$

In this case, Sₘₐₓ denotes maximum zoom magnification when a screen is converted, S_{c} denotes current zoom magnification, and Z denotes a function that normalizes a ratio of screen zoom magnification into a value in the range of 0 to 1. That is, when the distance between the hyperlink and the pointer is increased, the transparency of the preview thumbnail is increased, and when the zoom magnification is increased, the transparency of the preview thumbnail is decreased.

The size of the preview thumbnail 330 of the hyperlink 320 can be calculated by Equation 3.

$${Th}_{n} = [ \frac{Z ( \frac{{d}_{1}}{{d}_{n}} ) + \frac{{S}_{c}}{{S}_{max}}}{2} ] \times {Th}_{max} \qquad ( 3 )$$

At this time, when it is assumed that the maxim size of the preview thumbnail 330 is Thₘₐₓ, it can be understood that the size of the preview thumbnail 330 is decreased as the distance between the hyperlink and the pointer 310 is increased, and when the zoom magnification is increased, the size of the preview thumbnail 330 is increased.

Equations 2 and 3 are only used to define the size and transparency of the preview thumbnail 330 according to the distance between the pointer 310 and the hyperlink 320 and the zoom magnification. However, the invention is not limited thereto, and various modifications and changes can be made.

FIGS. 8 and 9 are diagrams illustrating a location of a preview thumbnail 330 at a hyperlink 320 according to an embodiment of the invention. As shown in FIG. 8, the preview thumbnail 330 may be displayed at the central location of the hyperlink 320. As the screen is enlarged, the size of the preview thumbnail 330 can be increased from the center of the hyperlink 320. Alternatively, the preview thumbnail 330 of the hyperlink 320, which is closest to the pointer 310 among the preview thumbnails 330 displayed at the centers of the hyperlinks 320, can move to the center of the web browser 300 as the magnification increases (that is, the size of the preview thumbnail 330 increases). The preview thumbnail 330 of the hyperlink 320, which is closest to the pointer 310, may be converted into a next screen as the zoom magnification increases. As a result, the transparency of the preview thumbnail 330 is decreased, the screen moves to the center of the web browser 300 at the same time as the increase in the size of the preview thumbnail 330, and the screen is converted. Accordingly, the screen can be smoothly converted.

Alternatively, as shown in FIG. 9, the preview thumbnail 330 can be displayed on the adjacent surface of the hyperlink 320, such that the preview thumbnail 330 can be displayed without blocking words shown by the hyperlink 320.

At this time, a shape of the preview thumbnail 330 may be a rectangle, a circle, a triangle, or a polygon. However, the preview thumbnail 330 is displayed in a triangle in FIGS. 8 and 9.

A web-browser-searching apparatus 500 using a zoom according to an embodiment of the invention will now be described.

The web-browser-searching apparatus 500 includes an input device 510, a distance-calculating unit 520, a hyperlink-selection/display unit 530, and a screen-converting unit 540.

The input device 510 may be a mouse or a remote controller, which has a function of locating the pointer 310 on the web browser 300 and a zoom function of enlarging and reducing a screen. However, the invention is not limited thereto.

The distance-calculating unit 520 calculates the distance between the pointer 310 and the hyperlinks on the web browser 300. The method of calculating the distance is represented by Equation 1.

The hyperlink-selection/display unit 530 selects one or more hyperlinks 320 around the pointer 310 on the basis of the distance between the hyperlinks and the pointer 310, which is calculated by the distance-calculating unit 520, and displays the selected hyperlinks. At this time, the hyperlink-selection/display unit 530 selects and displays the predetermined number of hyperlinks 320, in which the distance between the pointer 310 and the hyperlinks, by comparing the distance between the pointer 310 and the hyperlinks 320. Further, the hyperlinks 320, which exist in a range of a rectangular or circular predetermined area on the basis of the pointer 310, may be selected and displayed. The selected hyperlinks 320 may be displayed by highlighting the boundaries between the hyperlinks 320, as shown in FIG. 3.

If the screen is enlarged by the input device 510 and the predetermined enlargement range is exceeded, the screen-converting unit 540 outputs a page, which is linked to one of the hyperlinks 320 displayed by the hyperlink-selection/display unit 530, to an entire screen of the web browser 300 so as to convert the screen. Preferably, the screen-converting unit 540 displays the page, which is linked to the hyperlink 320a closest to the pointer 310, on the entire screen of the web browser 300 so as to convert the screen.

Further, if the screen is reduced by the input device 510 to be out of the predetermined reduction range, the screen-converting unit 540 can display the previous screen before the screen having been converted by the screen enlargement on the entire screen so as to convert the screen.

The web-browser-searching apparatus 500 using the zoom may further include a preview-thumbnail-display unit 535. While the screen is enlarged, the preview-thumbnail-display unit 535 shows the actual content of the pages, which are linked to the selected and displayed hyperlinks 320 around the pointer 310, in the form of preview thumbnails 330.

At this time, the size of the preview thumbnail 330 increases as the zoom magnification increases, and the transparency of the preview thumbnail 330 decreases as the zoom magnification increases. Further, the size of the preview thumbnail 330 increases as the distance between the preview thumbnail 330 and the pointer 310 becomes short, and the transparency of the preview thumbnail 330 decreases as the distance between the preview thumbnail 330 and the pointer 310 becomes short.

Further, the preview-thumbnail-display unit 535 displays the preview thumbnails 330 at the central locations of the hyperlinks 520. While the screen is enlarged, the preview-thumbnail-display unit 535 can make the preview thumbnail 330a, which is closest to the pointer 310, move to the center of the screen. Alternatively, the preview-thumbnail-display unit 535 displays the preview thumbnails 330 on the adjacent surfaces of the hyperlinks 320 so as not to block the hyperlinks 320.

Although the present invention has been described in connection with the exemplary embodiments of the present invention, it will be apparent to those skilled in the art that various modifications and changes may be made thereto without departing from the scope and spirit of the present invention. Therefore, it should be understood that the above embodiments are not limitative, but illustrative in all aspects.

According to the method and apparatus for searching a web browser using zoom according to the embodiment of the invention, the following effects can be achieved.

First, the screen is enlarged and reduced by using the zoom so that the screen can be smoothly converted on the web browser, and the web browser can be searched.

Second, the preview thumbnails of the plurality of hyperlinks, which are adjacent to the pointer, are displayed between the plurality of hyperlinks. Therefore, the user can recognize the content of the plurality of hyperlinks without selecting the hyperlinks.

1. A method of searching a web browser, comprising:
locating a pointer on a web browser using an input device;
selecting one or more hyperlinks on the basis of the distance between the pointer and hyperlinks, and displaying the hyperlinks; and
outputting, when a screen of the web browser is enlarged and a size of the screen is out of a predetermined enlargement range, a page, which is linked to one of the selected and displayed hyperlinks, to an entire screen of the web browser.

2. The method of claim 1, wherein the predetermined number of hyperlinks, which are close to the pointer, are selected by comparing the distance between the pointer and the hyperlinks.

3. The method of claim 1, wherein the hyperlinks, which exist within a range of the predetermined distance from a location of the pointer, are selected.

4. The method of claim 1, wherein the boundaries between the selected hyperlinks are highlighted and displayed.

5. The method of claim 1, wherein, in the outputting of the page to the entire screen, a page, which is linked to a hyperlink closest to the pointer among the selected and displayed hyperlinks, is output to the entire screen of the web browser.

6. The method of claim 1, wherein the outputting of the page to the entire screen comprises;
displaying a preview thumbnail showing content of a page that is linked to each of the selected and displayed hyperlinks, while the screen is enlarged.

7. The method of claim 6, wherein the size of the preview thumbnail increases as the screen is enlarged.

8. The method of claim 6, wherein the transparency of the preview thumbnail decreases as the screen is enlarged.

9. The method of claim 6, wherein the size of the preview thumbnail increases when the distance between the pointer and the preview thumbnail decreases.

10. The method of claim 6, wherein the transparency of the preview thumbnail decreases when the distance between the pointer and the preview thumbnail decreases.

11. The method of claim 6, wherein:
the preview thumbnail is displayed at the center of the hyperlink, and
a preview thumbnail of a hyperlink, which is closest to the pointer among the selected and displayed hyperlinks while the screen is enlarged, moves to the center of the web browser.

12. The method of claim 6, wherein the preview thumbnail is displayed on an adjacent surface of the hyperlink so as not to block the hyperlink.

13. The method of claim 1, further comprising:
outputting, when the screen of the web browser is reduced and the size of the screen is out of a predetermined reduction range, a screen right before the page, which is linked to one of the selected and displayed hyperlinks output to the entire screen of the web browser.

14. An apparatus for searching a web browser using a zoom function, comprising:
an input device locating a pointer on a web browser and enlarging and reducing a screen of the web browser;
a distance-calculating unit calculating the distance between the pointer and hyperlinks;
a hyperlink-selection/display unit selecting one or more hyperlinks on the basis of the distance and displaying the selected hyperlinks; and
a screen-converting unit outputting, when the screen of the web browser is enlarged and the size of the screen is out of a predetermined enlargement range, a page, which is linked to one of the selected and displayed hyperlinks, to an entire screen of the web browser.

15. The apparatus of claim 14, wherein the hyperlink-selection/display unit selects the predetermined number of hyperlinks, which are close to the pointer, by comparing the distance between the pointer and the hyperlinks.

16. The apparatus of claim 14, wherein the hyperlink-selection/display unit selects the hyperlinks that exist within a range of the predetermined distance from the pointer location.

17. The apparatus of claim 14, wherein the hyperlink-selection/display unit displays the selected hyperlinks by highlighting the boundaries between the selected hyperlinks.

18. The apparatus of claim 14, wherein the screen-converting unit outputs a page, which is linked to a hyperlink closest to the pointer among the selected and displayed hyperlinks, to the entire screen of the web browser.

19. The apparatus of claim 14, further comprising:
a preview-thumbnail-display unit displaying a preview thumbnail showing content of a page that is linked to each of the selected and displayed hyperlinks while the screen is enlarged.

20. The apparatus of claim 19, wherein the preview-thumbnail-display unit displays the preview thumbnail such that a size of the preview thumbnail increases as the screen is enlarged.

21. The apparatus of claim 19, wherein the preview-thumbnail-display unit displays the preview thumbnail such that the transparency of the preview thumbnail decreases as the screen is enlarged.

22. The apparatus of claim 19, wherein the preview-thumbnail-display unit displays the preview thumbnail such that the size of the preview thumbnail increases when the distance between the pointer and the preview thumbnail decreases.

23. The apparatus of claim 19, wherein the preview-thumbnail-display unit displays the preview thumbnail such that the transparency of the preview thumbnail decreases when the distance between the pointer and the preview thumbnail decreases.

24. The apparatus of claim 19, wherein the preview-thumbnail-display unit displays the preview thumbnail at the center of the hyperlink, and moves a preview thumbnail of a hyperlink, which is closest to the pointer among the selected and displayed hyperlinks while the screen is enlarged, to the center of the web browser.

25. The apparatus of claim 19, wherein the preview-thumbnail-display unit displays the preview thumbnail on an adjacent surface of the hyperlink so as not to block the hyperlink.

26. The apparatus of claim 14, wherein the screen-converting unit outputs, when the screen of the web browser is reduced and the size of the screen is out of a predetermined reduction range, a screen right before the page, which is linked to one of the selected and displayed hyperlinks, is output to the entire screen of the web browser.
